(19) United States
(12) Patent Application Publication
(10) Pub. No.: US 2014/0122007 A1
(43) Pub. Date: May 1, 2014

(54) METHOD AND A SYSTEM FOR DETERMINING THE ANGULAR POSITION OF A ROTARY ELEMENT, AND A BEARING INCLUDING SUCH A SYSTEM

(71) Applicants: Stephane Moisy, Lile-Bouchard (FR); Alexis Gatesoupe, Monnaie (FR)

(72) Inventors: Stephane Moisy, Lile-Bouchard (FR); Alexis Gatesoupe, Monnaie (FR)

(21) Appl. No.: 13/818,683

(22) PCT Filed: Aug. 24, 2010
(86) PCT No.: PCT/IB2010/002448

§ 371 Date: May 3, 2013

(51) Int. Cl. G01D 5/244

(52) U.S. Cl. CPC G01D 5/2448
USPC 702/94

(57) ABSTRACT

This method determines an angular position of a rotary element rotating with respect to a stationary element where a magnetic ring rotatably fastened with the rotary element is arranged with respect to a set of N regularly distributed sensors, with N≧3. Each sensor is suitable for issuing a unitary electric signal representative of a magnetic field generated by the magnetic ring. In this method, one computes a first sum of the signals issued by all N sensors and compares this sum to a first reference value. If the first sum equals the first reference value, one uses the signals of all N sensors to compute a signal representative of an instantaneous value of an angle representative of the angular position of the rotary element. If the first sum does not equal the first reference value, a series of defined steps to optionally obtain the instantaneous value are provided.

### TECHNICAL FIELD OF THE INVENTION

This invention relates to a method for determining the angular position of a rotary element, such as a ring of a ball bearing, or the equivalent. The invention also relates to a system which is suitable for implementing this method and to a bearing incorporating such a system.

### BACKGROUND OF THE INVENTION

WO-A-2007/077389 discloses Hall effect sensors regularly distributed around a magnetic ring to supply sinusoidal type electric signals that enable the angular position of a rotary element to be determined by computation. If one of the sensors is faulty, then the complete system becomes non-operational.

US-A-2005/0189938 teaches the re-construction of a signal from a faulty sensor on the basis of a Bell curve. Such an approach is not accurate enough to allow an efficient determination of an angular position.

### SUMMARY OF THE INVENTION

The invention aims at providing a method which enables an accurate determination of an angular position of a rotary element, even if one or even several sensor(s) are faulty.

To this end, the invention relates to a method for determining an angular position of a rotary element rotating with respect to a stationary element in a system where a magnetic ring fast in rotation with the rotary element is arranged with respect to a set of N sensors, with N larger than or equal to 3, each sensor being suitable for issuing a unitary electric signal representative of a magnetic field generated by the magnetic ring, while the sensors are regularly distributed around a rotation axis of the magnetic ring. This method comprises at least the following steps consisting in:
a) computing a sum of the signals issued by all N sensors,
b) comparing the sum of step a) to a first reference value,
c) if the sum of step a) equals the first reference value, using the signals of all N sensors to compute a signal representative of an instantaneous value of an angle representative of the angular position of the rotary element,
d) if the sum of step a) does not equal the first reference value, selecting a subset of P sensors amongst the N sensors, with P strictly inferior to N,
e) computing at least one virtual signal corresponding to the signal that would be generated by a sensor in a set of P sensors regularly distributed around the rotation axis,
f) computing a sum of P signals including all virtual signals computed at step e) and at least one signal issued by a sensor of the subset,
g) comparing the sum of step f) to another reference value,
h) if the sum of step f) equals the other reference value, using the signals constituting the sum of step f) to compute a signal representative of an instantaneous value of the angle representative of the angular position of the rotary element,
i) if the sum of step f) does not equal the second reference value, selecting another subset of P sensors amongst the N sensors and implementing again steps e) to h).

Thanks to the invention, the selection of P sensors amongst the N sensors of the system and the computation of virtual signals enable to build a set of signals that are usable to accurately determine the angular position of a rotary element, even if some sensors, which actually do not belong to the subset of P sensors, are faulty.

According to aspects of the invention that are advantageous but not compulsory, such a method may incorporate one or more of the following features:
The method includes a further step j) consisting in, if all preset selections of P sensors amongst the N sensors have been performed in steps d) and i) without having the sum of step f) equal a reference value, stopping the method and/or sending an error message.
In step e), the virtual signal is computed as a sum of vectors corresponding to the projection, on a radius with respect to the axis of rotation that represents the position of a sensor in a set of P regularly distributed sensors, of the signal issued by at least one of the P sensors.
P equals N−1 or N−2.
N equals 5 and P equals 3. In such a case, in steps d) and i), a first sensor is advantageously selected and second and third sensors are selected as the two sensors which are not adjacent the first sensor. In particular, in step e), two virtual signals can be computed on the basis of the signals respectively issued by the second and third sensors. The two virtual signals can be computed as

$$U 3 V ( t ) = U 3 ( t ) - 0 , 409 \frac{\vert U 3 ( t ) \vert}{\vert U 4 ( t ) \vert} * U 4 ( t ) and$$

$$U 4 V ( t ) = U 4 ( t ) - 0 , 409 \frac{\vert U 4 ( t ) \vert}{\vert U 3 ( t ) \vert} * U 3 ( t )$$

where t is an instant, U3(t) is the signal issued by the second sensor and U4(t) is the signal issued by the third sensor at instant t.
N equals 5 and P equals 2. In such a case, in step d), two adjacent sensors are advantageously selected. In particular, in step e), one virtual signal can be computed on the basis of the signals respectively issued by the two sensors. The virtual signal can be computed as U3V(t)=U3(t)−0.309 U2(t) where t is an instant, U2(t) is the signal issued by the first sensor and U3 is the signal issued by the second sensor at instant t.

The invention also provides a system for determining the angular position of a rotary element with respect to a stationary element, in particular by implementing a method as mentioned here-above. This system comprises a magnetic ring fast in rotation with the rotary element and arranged with respect to a set of N sensors, with N larger than or equal to 3, each sensor being suitable for issuing a unitary electric signal representative of the magnetic field generated by the magnetic ring and the sensors being regularly distributed around a rotation axis of the magnetic ring. The system of the invention includes means for automatically implementing at least steps a) to i) mentioned here-above.

Finally, the invention provides a bearing comprising a stationary ring and a rotary ring, together with a system as mentioned here-above.

### BRIEF DESCRIPTION OF THE DRAWINGS

The invention can be better understood and other advantageous thereof appear more clearly in the light of the following description of several embodiments of a method in accordance with its principle, given solely by way of example and made with reference to the annexed drawings in which:

FIG. 1 is a diagram showing the principle of a system in accordance with the invention implementing a method in accordance with the invention,

FIG. 2 is a schematic representation of the repartition of the sensing cells of the system of FIG. 1 around an axis of rotation,

FIG. 3 is a schematic representation similar to FIG. 2 for a system including three sensing cells,

FIG. 4 is a schematic representation similar to FIG. 2 when two sensing cells are not used, in an approach similar to the one of FIG. 3,

FIG. 5 shows the distribution of some vectors representing analog electrical signals in a plane perpendicular to the axis of rotation of the magnetic ring of the system of FIG. 1, and

FIG. 6 is a block diagram of a method in accordance with the invention.

### DETAILED DESCRIPTION OF SOME EMBODIMENTS

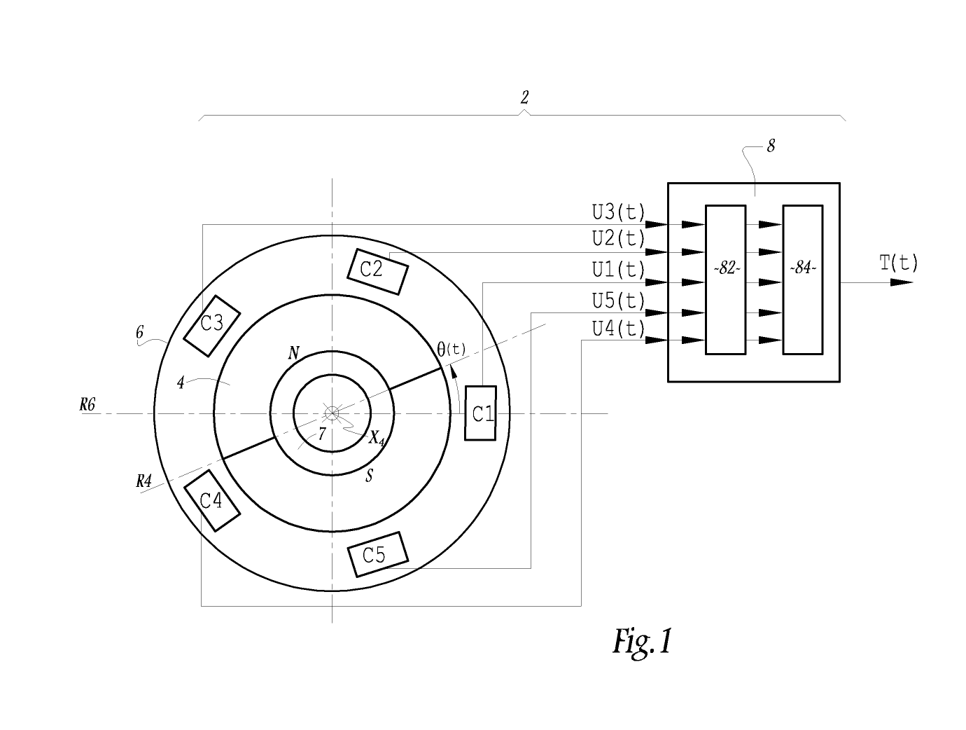

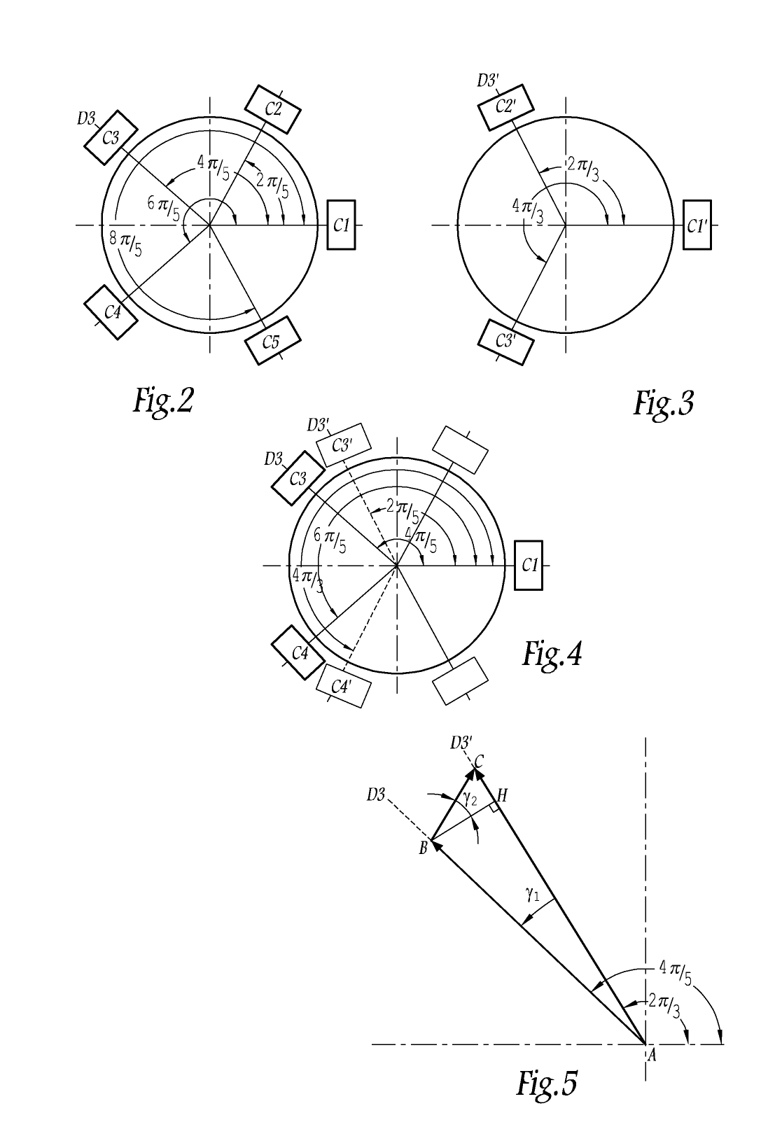

The system 2 shown in FIG. 1 comprises a magnetic ring 4 having two poles, namely a North pole N and a South pole S. Ring 4 rotates about an axis X4 perpendicular to the plane of FIG. 1. Five Hall effect cells C1 to C5 are regularly distributed around axis X4 and around ring 4. Each cell C1 to C5 delivers an analog electric signal in the form of a voltage that varies as a function of time.

Cells C1 to C5 are, for instance, Hall effect sensors.

Cells C1 to C5 are mounted on a stationary part 6. Part 6 is stationary insofar as it does not rotate around axis X4. For example, stationary part 6 is fast with the outer stationary ring of a bearing, whereas magnetic ring 4 is fast in rotation with an inner rotating ring 7 of the bearing. System 2 allows to determine the angular position of items 4 and 8 with respect to axis 4. The angular position of ring 4 about axis X4 is identified by an angle θ between a radius R6 that is drawn horizontally in FIG. 1 and that intersects axis X4 and a radius R4 passing via the two interfaces between the North and South poles of the ring 4. This angle varies as a function of time and its value is written θ(t).

For i representing a natural integer in the range 1 to 5, the voltage delivered by sensor Ci depends on time t and is written Ui(t). In normal operation of system 2, at an instant t, signals Ui(t) are conditioned and combined using an approach analogous to that mentioned in WO-A-2007/0773893, the content of which is incorporated in the present application by reference, in order to create two signals at a phase difference of 90° electrical, enabling the angular position of ring 4 relative to stationary part 6 to be calculated.

The signals Ui(t) are sent to unit 8 at a frequency that is a function of the speed of rotation expected of the ring 4, e.g. once every 1 to 10 milliseconds.

Unit 8 is designed to issue an electric signal that varies as a function of time and that is representative of the instantaneous value of angle θ. The value of this signal as a function of time is written T(t).

Unit 8 comprises a module 82 for conditioning the signals Ui(t) and a module 84 for calculating the value of the signal T(t) as a function of time. The calculation performed by the module 84 is based on the signals as conditioned in the module 82. In particular, the module 82 serves to transform the analog signals constituted by the voltages Ui(t) into digital signals that are suitable for processing by a computer incorporated in the module 84.

Consider a general configuration in which N sensors are distributed circumferentially regularly around a ring having P poles. Under such circumstances, and taking the angular position of a first sensor C1 as a reference position, the various sensors have angular positions about the axis X4 that satisfy the relationship:

$${ϕ}_{i} = ( i - 1 ) * \frac{2 π}{P * N} + k * \frac{2 π}{P} + C$$

where i is a natural integer in the range 1 to N, k is a relative integer, and C is a real constant representing the position of the first sensor.

Each signal Uᵢ(t₁) for i lying in the range 1 to N may be expressed in the form:

Uᵢ(t₁)=Oᵢ+Aᵢ·sin(ωt+φᵢ)

where φᵢ s defined as above, ω is equal to the angular frequency, and Oᵢ is equal to the offset of the signal Uᵢ(t₁) relative to the value zero, this offset being equal to 2.5 volts for example for a Hall effect sensor, while Ai is the sinusoidal amplitude of the signal Uᵢ(t) about the value Oᵢ.

At any instant t, the sum S(t) of the voltages from the N sensors of the device 2 is expressed as follows:

$$S ( t ) = {\sum }_{i = 1}^{N} {U}_{i} ( t ) = {\sum }_{i = 1}^{N} ( {O}_{i} + {A}_{i} \cdot sin ( ω \cdot t + {ϕ}_{i} ) )$$

By developing this expression, the sum S(t) may be expressed as a function of time in the form:

S(t)=Oₛ+Aₛ·sin(ω·t+φₛ)

with:

$$\{ \begin{matrix}a = {\sum }_{i = 1}^{N} {A}_{i} \cdot cos {ϕ}_{i} \\ b = {\sum }_{i = 1}^{N} {A}_{i} \cdot sin {ϕ}_{i}\end{matrix}$$

and:

$${O}_{S} = {\sum }_{i = 1}^{n} {O}_{i}$$

$${A}_{S} = \sqrt{{a}^{2} + {b}^{2}}$$

$${ϕ}_{S} = \{ \begin{matrix}arctan ( \frac{b}{a} ) & if a > 0 \\ arctan ( \frac{b}{a} ) + π & if a < 0\end{matrix}$$

In the particular circumstance where the elements Ci are identical, it may be considered that the offset values Oᵢ and the amplitude values A are the same for i lying in the range 1 to N. The sum S(t) may be simplified as follows:

$$S ( t ) = {\sum }_{i = 1}^{N} {U}_{i} ( t ) = {\sum }_{i = 1}^{N} {O}_{i} = constant$$

Consider one electrical period, given that one mechanical period (one rotation of the rotary element 7 and of the magnetic ring 4) makes up P electrical periods, then:

Uᵢ(t)=Oᵢ+Aᵢ·sin(ωt+Φᵢ)

### With:

$${Φ}_{i} = P * ϕ i = ( i - 1 ) * \frac{2 π}{N} + k * 2 π + C$$

### Thus:

$$S ( t ) = {\sum }_{i = 1}^{N} {U}_{i} ( t ) = {\sum }_{i = 1}^{N} ( {O}_{i} + {A}_{i} \cdot sin ( ω \cdot t + {Φ}_{i} ) )$$

### Whence:

$$\begin{matrix}S ( t ) = {\sum }_{i = 1}^{N} ( {O}_{i} + {A}_{i } \cdot sin ( ω \cdot t + ( i - 1 ) * \frac{2 π}{N} + k * 2 π + C ) ) \\ = {\sum }_{i = 1}^{N} ( {O}_{i} ) + {\sum }_{i = 1}^{N} ( {A}_{i } \cdot sin ( ω \cdot t + ( i - 1 ) * \frac{2 π}{N} + k * 2 π + C ) )\end{matrix}$$

It is assumed that each cell delivers a signal of identical amplitude Aᵢ. Thus:

∀iε[1;N], Aᵢ=const=A

### Whence:

$$S ( t ) = {\sum }_{i = 1}^{N} ( {O}_{i} ) + A * {\sum }_{i = 1}^{N} sin ( ω \cdot t + ( i - 1 ) * \frac{2 π}{N} + k * 2 π + C )$$

### Furthermore:

sin(α+k*2π)=sin(α), kεZ

### Whence:

$$\begin{matrix}S ( t ) = {\sum }_{i = 1}^{N} ( {O}_{i} ) + A * {\sum }_{i = 1}^{N} sin ( ω \cdot t + ( i - 1 ) * \frac{2 π}{N} + C ) \\ = {\sum }_{i = 1}^{N} ( {O}_{i} ) + A * {\sum }_{i = 1}^{N} ( \begin{matrix}sin ( ω \cdot t + C ) * cos ( ( i - 1 ) * \frac{2 π}{N} ) + \\ cos ( ω \cdot t + C ) * sin ( ( i - 1 ) * \frac{2 π}{N} )\end{matrix} ) \\ = {\sum }_{i = 1}^{N} ( {O}_{i} ) + A * {\sum }_{i = 1}^{N} ( sin ( ω \cdot t + C ) * cos ( ( i - 1 ) * \frac{2 π}{N} ) ) + \\ A * {\sum }_{i = 1}^{N} ( cos ( ω \cdot t + C ) * sin ( ( i - 1 ) * \frac{2 π}{N} ) ) \\ = {\sum }_{i = 1}^{N} ( {O}_{i} ) + A * sin ( ω \cdot t + C ) {\sum }_{i = 1}^{N} ( cos ( ( i - 1 ) * \frac{2 π}{N} ) ) + \\ A * cos ( ω \cdot t + C ) {\sum }_{i = 1}^{N} ( sin ( ( i - 1 ) * \frac{2 π}{N} ) )\end{matrix}$$

However at all instants t:

$$\{ \begin{matrix}A \neq 0 \\ sin ( ω t + C ) \neq 0 \\ cos ( ω t + C ) \neq 0\end{matrix}$$

Proving that

$$S ( t ) = {\sum }_{i = 1}^{N} {U}_{i} ( t ) = {\sum }_{i = 1}^{N} {O}_{i} = constant$$

thus amounts to proving that

$${\sum }_{i = 1}^{N} ( cos ( ( i - 1 ) * \frac{2 π}{N} ) ) = 0$$

$$and$$

$${\sum }_{i = 1}^{N} ( sin ( ( i - 1 ) * \frac{2 π}{N} ) ) = 0$$

For this purpose, consideration is given to the following integral which by definition is zero over one period:

$${\int }_{0}^{2 π} sin ( θ ) d θ = 0$$

By making Riemann integrals discrete at a constant pitch, with the signal being quantized into N equal portions corresponding to the phase offset of 2π/N of the N cells, it is possible to write:

$${\int }_{0}^{2 π} sin ( θ ) d θ = 0 ⇔ {\sum }_{i = 1}^{N} \frac{2 π}{N} sin ( ( i - 1 ) * \frac{2 π}{N} ) = 0$$

### However:

$${\sum }_{i = 1}^{N} \frac{2 π}{N} sin ( ( i - 1 ) * \frac{2 π}{N} ) = 0 ⇔ \frac{2 π}{N} {\sum }_{i = 1}^{N} sin ( ( i - 1 ) * \frac{2 π}{N} ) = 0 ⇒ {\sum }_{i = 1}^{N} sin ( ( i - 1 ) * \frac{2 π}{N} ) = 0$$

The same reasoning applies to:

$${\int }_{0}^{2 π} cos ( θ ) d θ = 0$$

### Thus:

$${\sum }_{i = 1}^{N} ( cos ( ( i - 1 ) * \frac{2 π}{N} ) ) = 0$$

$$and$$

$${\sum }_{i = 1}^{N} ( sin ( ( i - 1 ) * \frac{2 π}{N} ) ) = 0$$

### However:

$$S ( t ) = {\sum }_{i = 1}^{N} ( {O}_{i} ) + A * sin ( ω \cdot t + C ) {\sum }_{i = 1}^{N} ( cos ( ( i - 1 ) * \frac{2 π}{N} ) ) + A * cos ( ω \cdot t + C ) {\sum }_{i = 1}^{N} ( sin ( ( i - 1 ) * \frac{2 π}{N} ) )$$

### Thus:

$$S ( t ) = {\sum }_{i = 1}^{N} {O}_{i}$$

With ∀iε[1;N], Oᵢ=const
It is thus shown that:

$$S ( t ) = {\sum }_{i = 1}^{N} {O}_{i} = constant \qquad ( Equation 1 )$$

In the example of FIG. 1, N equals 5 and P equals 2. Thus, the following is normally satisfied, if all sensors work correctly:

S(t)=U1(t)+U2(t)+U3(t)+U4(t)+U5(t)=constant=R1

where R1 is a first reference value corresponding to the normal value for S(t).

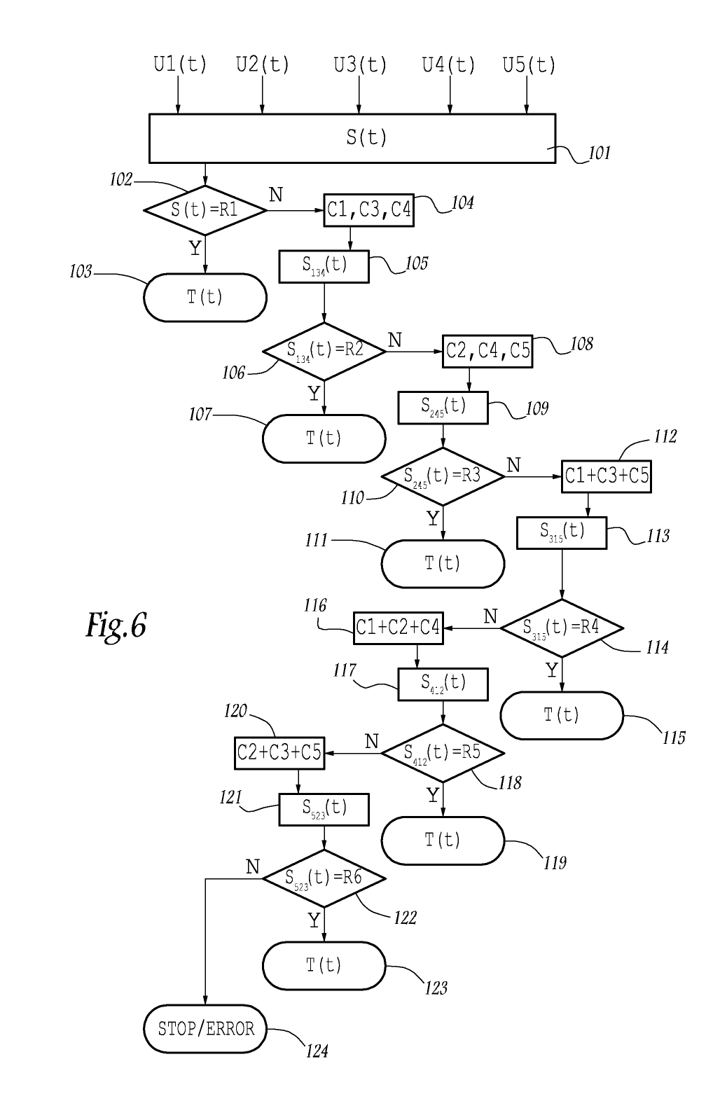

In a first step 101 of the method represented on FIG. 6, one computes the above-mentioned sum S(t).

Then, in a step 102, one compares this value S(t) with reference value R1. S(t) is considered to equal R1 if S(t) is larger than a low predetermined threshold value LR1 and smaller than a high predetermined threshold value HR1. For instance, values LR1 and HR1 are respectively chosen equal to 95% and 105% of R1.

If the result of the comparison of step 102 is positive, then system 2 is considered to work correctly and a further step 103 is implemented where all signals Ui(t), for i between 1 and 5, are used by unit 8 to compute signal T(t).

If the result of the comparison of step 102 is not positive, then one considers that at least one of sensors C1 to C5 is faulty.

Then, and as shown in step 104, a subset of three cells, amongst cells C1 to C5 is selected. Actually, this subset is made of cells C1, C3 and C4. In other words, one selects in step 104 three cells in order to build a virtual angular position determination system including only these three cells.

If these cells were regularly distributed around axis X4, they would have the position of cells C1′, C3′ and C4′ on FIG. 3. This is actually not the case as shown on FIG. 4.

Indeed, the angular offset between cell C1 and C3 equals 4π/5 whereas the angular offset between cells C1 and C4 equals 6π/5. On the other hand, in the configuration of FIG. 3, the angular offset between cells C1′ and C3′ equals 2π/3 and the angular offset between cells C1′ and C4′ equals 4π/3.

In order to assess if cells C1, C3 and C4 can be used by unit 8 to compute the value T(t), it is essential to determine if the three cells C1, C3 and C4 work correctly.

One considers a signal that would be emitted by cell C3 if it were located as cell C3′. In other words, one considers a virtual signal U3V(t) which is based, amongst others, on the signal of cell C3 and is corrected to correspond to the signal issued by cell C3 in the location of cell C3′ with respect to axis X4.

Signal U3(t) can be represented as vector \vec{AB} on FIG. 5, whereas signal U3V(t) is represented by vector \vec{AC} on this figure. FIG. 5 shows that \vec{AC}=\vec{AB}+\vec{BC}

Actually, \vec{BC} can be expressed as a function of U4(t), that is as a function of the signal issued by cell C4.

If one considers the angle γ₁ between vectors \vec{AB} and \vec{AC}, then its sine satisfies the following equation:

sin(γ1)=BH/AB=BH/|U3(t)|

where H is the orthogonal projection of point B on a straight line D3′ including points A and C. Actually, line D3′ is a radius with respect to axis X4 where cell C3′ is located on FIG. 3.

On the other hand, if one considers angle γ₂ between vectors \vec{BH} and \vec{BC}, then its cosine equals |\vec{BH}/|\vec{BC}|. In view of the values of the angles 2π/3 and 4π/5 considered here-above, γ₂ equals 2π/5 minus the angle between \vec{AB} and \vec{BH}. Computations show that γ₂ equals π/30 or 6°.

Thus, one has the following relationship:

$$\vert \vec{BC} \vert = \vert \vec{BH} \vert / cos {γ}_{2} = \frac{\vert \vec{AB} \vert * sin {γ}_{1}}{cos {γ}_{1}}$$

On the other hand, γ₁ equals 4π/5−2π/3=2π/15.

Thus, \vec{BC} can be expressed as a function of |U3(t)| with the following equation:

$$\vert \vec{BC} \vert = \frac{U 3 ( t ) * sin ( 2 π / 15 )}{cos ( π / 30 )} = 0 , 409 U 3 ( t )$$

Thus, the output signal U3V(t) of cell C3 connected to correspond to the signal of a virtual cell C3′ that would lie on line D3′, can be expressed as:

$$U 3 V ( t ) = U 3 ( t ) * \vec{AC} = U 3 ( t ) - 0 , 409 * \frac{\vert U 3 ( t ) \vert}{\vert U 4 ( t ) \vert} U 4 ( t )$$

Similar computations show that a corrected value U4V(t) of signal U4(t) can be computed, as if cell C4 were located as cell C4′, with the following equation:

$$U 4 C ( t ) = U 4 ( t ) - 0 , 409 \frac{\vert U 4 ( t ) \vert}{\vert U 3 ( t ) \vert} * U 3 ( t )$$

If the three cells C1, C3 and C4, with the corrected values for cells C3 and C4, can work as a set of cells accurate enough to determine the angular position of magnetic ring 4, then equation 1 with respect to the constant feature of the sum of the signals of regularly spread cells must apply.

Thus, in a subsequent step 105, unit 8 computes the corrected sum of signals U1(t), U3(t) and U4(t) as:

S₁₃₄(t)=U1(t)+U3V(t)+U4V(t)

As mentioned here-above, this sum should be constant. This is verified in a further step 106 where the value of S₁₃₄(t) is compared to a second reference value R2, with a low threshold value LR2 and a high threshold value HR2 defined as for the first reference value R1. If the result of this comparison is positive, that is if the corrected sum S₁₃₄(t) can be considered to be constant, then unit 8 uses cells C1, C3 and C4 to compute signal T(t) in a further step 107, in a way similar to step 103.

If this is not the case, that is if the sum S₁₃₄(t) is not constant, then one proceeds to a further step 108 where another set of three sensors is selected, namely sensors C2, C4 and C5. then, in a subsequent step 109, another sum S₂₄₅(t) is computed on the basis of the output signal U2(t) of cell C2 and of virtual signals U4V(t) and U5V(t) computed from the output signals U4(t) and U5(t) of cells C4 and C5 as explained here-above for signals U3V(t) and U4V(t). In a further step, the fact that this sum S₂₄₅(t) is constant is verified in a further step 110, as in step 106, by comparison to a reference value R3.

If the result of this verification is positive, one uses cells C2, C4 and C5 in a further step 111 for computation of the angular value T(t) in unit 8.

If such is not the case, unit 8 switches to another step 112 where a new subset of three sensors is selected, namely sensors C1, C3 and C5.

The method of the invention goes on as long as unit 8 has not identified a set of three cells enabling a constant sum Sᵢⱼₖ(t) to be built as explained with respect to steps 104 and 108 here-above, where i corresponds to the order number of a cell whose output signal is used without modifications and j and k correspond to the order numbers of cells whose output signals are used to build virtual output signals UjV and UkV as explained here-above.

The method of the invention goes on with steps 111 to 123 where further attempts are made to identify such a set of three cells. Steps 112, 116 and 120 are similar to steps 104 and 108. Steps 113, 117 and 121 are similar to steps 105 and 109, steps 114, 118 and 122 are similar to steps 106 and 110 and steps 115, 119 and 123 are similar to steps 107 and 111.

Five attempts are actually made, each of them being centered on one cell C1 to C5 whose output signal is not corrected and two cells whose output signals are corrected to generate virtual signals, as explained here-above. Thus, one successively defines sums S₁₃₄(t), S₂₄₅(t), S₃₁₅(t), S₄₁₂(t) and S₅₂₃(t). In each set of three cells, the two cells whose output signals are used to build virtual signals are the ones which are not adjacent the cell whose output signal is not corrected.

If step 123 shows that sum S₅₂₃(t) computed as above is not constant, then one can consider that it is not possible to build a set of three cells which would give a satisfactory result and, in a step 124, the method is stopped and/or an error is issued.

Steps 101 to 124 are automatically performed by unit 8, on a regular basis, e.g. every 1 to 10 milliseconds.

References values R2 to R6 used in steps 106, 110, 114, 118 and 122 can be equal, which simplifies computations in unit 8. However, this is not compulsory.

The invention has been shown on the figures in case one starts with five cells in steps 101 and 102 and selects several groups of three cells in steps 104 to 123.

However, it is also possible to start from a group of five cells and select only two cells for building a subset.

In such a case, one chooses two adjacent cells, such as cells C2 and C3 in the example of FIG. 1 and the virtual value U3V(t) for cell C3 can be computed as U3V(t)=U3(t)−0.309 U2(t) if one assumes that the amplitudes of U3 and U2 are approximately equal.

The invention can also be implemented with a different number of cells, e.g. from a group of three original cells, where two cells are selected as a subset, or a group of five original cells where a group of four cells are selected as a sub-group.

Generally speaking, if one has a group of N cells in a system, one can select a sub-group of N−1, N−2 or N−3 cells to implement the invention.

1. A method for determining an angular position of a rotary element rotating with respect to a stationary element in a system where a magnetic ring rotatably fastened to the rotary element is arranged with respect to a set of N sensors (C1-C5), with N larger than or equal to 3, each sensor being suitable for issuing a unitary electric signal (U1(t)-U5(t)) representative of a magnetic field generated by the magnetic ring and the sensors being regularly distributed around a rotation axis (X4) of the magnetic ring, wherein the method comprises the steps of:
a) computing a sum (S(t)) of the signals (U1(t)-U5(t)) issued by all N sensors (C1-C5),
b) comparing the sum of step a) to a first reference value (R1),
c) if the sum of step a) equals the first reference value, using the signals of all N sensors to compute a signal (T(t)) representative of an instantaneous value of an angle (θ(t)) representative of the angular position of the rotary element,
d) if the sum of step a) does not equal the first reference value, selecting a subset of P sensors amongst the N sensors, with P strictly inferior to N,
e) computing at least one virtual signal (U3V(t), U4V(t)) corresponding to the signal that would be generated by a sensor (C3, C4) in a first set of P sensors (C1′-C3′) regularly distributed around the rotation axis (X4),
f) computing a sum (S₁₃₄(t) of P signals including all virtual signals (U3V(t), U4V(t)) computed at step e) and at least one signal (U1(t)) issued by a sensor of the first subset,
g) comparing the sum of step f) to a second reference value (R2),
h) if the sum of step f) equals the second reference value, using the signals constituting the sum of step f) to compute a signal (T(t)) representative of an instantaneous value of the angle (θ(t)) representative of the angular position of the rotary element,
i) if the sum of step f) does not equal the second reference value, selecting a second subset of P sensors amongst the N sensors and implementing again steps e) to h).

2. The method according to claim 1, further comprising
j) if all preset selections of P sensors amongst the N sensors have been performed in steps d) and i) without having the sum of step f) equal a reference value (R1-R6), stopping the method and/or sending an error message.

3. The method according to claim 1, wherein, in step e), the virtual signal (U3V(t), U4V(t)) is computed as a sum of vectors (\vec{AB}+\vec{BC}) corresponding to the projection, on a radius (D3′) with respect to the axis of rotation (X4) that represents the position of a sensor (C3′) in a set of P regularly distributed sensors, of the signals (U3V(t), U4V(t)) issued by at least one (C3, C4) of the P sensors.

4. The method according to claim 1, wherein P equals N−1 or N−2.

5. The method according to claim 4, wherein N equals 5 and P equals 3.

6. The method according to claim 5, wherein, in steps d) and i), a first sensor (C1) is selected and second and third sensors (C3, C4) are selected as the two sensors which are not adjacent the first sensor.

7. The method according to claim 6, wherein, in step e), two virtual signals are computed on the basis of the signals (U3(t), U4(t)) respectively issued by the second and third sensors (C3, C4).

8. The method according to claim 7, wherein the two virtual signals (U3(t), U4(t)) are computed as:
$$U 3 V ( t ) = U 3 ( t ) - 0 , 409 \frac{\vert U 3 ( t ) \vert}{\vert U 4 ( t ) \vert} * U 4 ( t )$$
$$and$$
$$U 4 V ( t ) = U 4 ( t ) - 0 , 409 \frac{\vert U 4 ( t ) \vert}{\vert U 3 ( t ) \vert} * U 3 ( t )$$
where t is an instant, U3(t) is the signal issued by the second sensor and U4(t) is the signal issued by the third sensor at instant t.

9. The method according to claim 1, wherein N equals 5 and P equals 2.

10. The method according to claim 9, wherein, in step d), two adjacent sensors (C2, C3) are selected.

11. The method according to claim 10, wherein, in step e), one virtual signal (U3V(t)) is computed on the basis of the signals (U2(t), U3(t)) respectively issued by the two sensors (C2, C3).

12. The method according to claim 10, wherein the virtual signal (U3V(t)) is computed as:
U3V(t)=U3(t)−0.309 U2(t)
where t is an instant, U2(t) is the signal issued by the first sensor and U3(t) is the signal issued by the second sensor at instant t.

13. A system for determining the angular position of a rotary element with respect to a stationary element, the system comprising a magnetic ring rotatably fastened to the rotary element and arranged with respect to a set of N sensors (C1-C5), with N larger than or equal to 3, each sensor being suitable for issuing a unitary electric signal (U1(t)-U5(t)) representative of the magnetic field generated by the magnetic ring and the sensors being regularly distributed around a rotation axis (X4) of the magnetic ring, wherein the system includes:
a) computing a sum (S(t)) of the signals (U1(t)-U5(t)) issued by all N sensors (C1-C5) is computed,
b) the sum of step a) is compared to a first reference value (R1),
c) if the sum of step a) equals the first reference value, the signals of all N sensors are used to compute a signal (T(t)) representative of an instantaneous value of an angle (θ(t)) representative of the angular position of the rotary element (7),
d) if the sum of step a) does not equal the first reference value, a subset of P sensors is selected amongst the N sensors, with P strictly inferior to N,
e) at least one virtual signal (U3V(t), U4V(t)) corresponding to the signal that would be generated by a sensor (C3, C4) in a set of P sensors (C1′-C3′) regularly distributed around the rotation axis (X4) is computed,
f) a sum (S₁₃₄(t) of P signals including all virtual signals (U3V(t), U4V(t)) computed at step e) and at least one signal (U1(t)) issued by a sensor of the subset is computed,
g) sum of step f) is compared to a second reference value (R2),
h) if the sum of step f) equals the reference value, the signals constituting the sum of step f) are used to compute a signal (T(t)) representative of an instantaneous value of the angle (θ(t)) representative of the angular position of the rotary element (7),
i) if the sum of step f) does not equal the second reference value, a second subset of P sensors is selected amongst the N sensors and implementing again steps e) to h).

14. A bearing comprising:
a stationary ring,
a rotary ring, and
a system including,
a sum (S(t)) of the signals (U1(t)-U5(t)) issued by all N sensors (C1-C5) being computed,
the sum of step a) to a first reference value (R1) being compared,
if the sum of step a) equals the first reference value, the signals of all N sensors are used to compute a signal (T(t)) representative of an instantaneous value of an angle (θ(t)) representative of the angular position of the rotary element (7),
if the sum of step a) does not equal the first reference value, a subset of P sensors are selected amongst the N sensors, with P strictly inferior to N,
at least one virtual signal (U3V(t), U4V(t)) corresponding to the signal that would be generated by a sensor (C3, C4) in a set of P sensors (C1′-C3′) regularly distributed around the rotation axis (X4) being computed,
a sum (S₁₃₄(t)) of P signals including all virtual signals (U3V(t), U4V(t)) computed at step e) and at least one signal (U1(t)) issued by a sensor of the subset being computed,
the sum of step f) is compared to a second reference value (R2),
if the sum of step f) equals the second reference value, the signals constituting the sum of step f) are used to compute a signal (T(t)) representative of an instantaneous value of the angle (θ(t)) representative of the angular position of the rotary element,
if the sum of step f) does not equal the second reference value, a second subset of P sensors is selected amongst the N sensors and implementing again steps e) to h).
